(19) United States
(12) Patent Application Publication
(10) Pub. No.: US 2026/0200386 A1
(43) Pub. Date: Jul. 16, 2026

(54) CUP HOLDER

(71) Applicant: Shenzhen JinChannel Innovation Technology Co., Ltd., SHENZHEN (CN)

(72) Inventors: Enqun LI, Shenzhen (CN); Canrong LIANG, Shenzhen (CN)

(73) Assignee: Shenzhen JinChannel Innovation Technology Co., Ltd., SHENZHEN (CN)

(21) Appl. No.: 19/017,216

(22) Filed: Jan. 10, 2025

(51) Int. Cl. B60N 3/10

(52) U.S. Cl. CPC B60N 3/10

(57) ABSTRACT

Disclosed is a cup holder including: a base plate, where a mounting post is mounted on the base plate, and a rotating frame is rotatably connected to the mounting post; where the rotating frame includes a rotating cylinder rotatably sleeved over the mounting post, a rotating ring is fixedly connected to the rotating cylinder, and a plurality of placing frames are distributed along the circumferential direction of the rotating ring; the placing frame includes a first placing ring and a second placing ring distributed in a layer, the first placing ring and the second placing ring are both split rings, the first placing ring and the second placing ring are respectively welded and fixed with the rotating ring, and the first placing ring and the second placing ring are connected via a vertical bar.

### TECHNICAL FIELD

The disclosure relates to the technical field of stowing cups on end, and more particularly to a cup holder.

### BACKGROUND

In the prior art, a vehicle-mounted cup is accommodated by an acrylic cup holder placed laterally. However, the above cup holder cannot be properly placed for a vehicle-mounted cup with a handle.

Therefore, how to provide a cup holder so as to facilitate the placement of a vehicle-mounted cup with a handle has become an urgent technical problem to be solved.

### SUMMARY

The technical problem to be solved by the disclosure is to provide a cup holder to facilitate the placement of a vehicle-mounted cup with a handle.

Thus, embodiments of the disclosure disclose a cup holder including: a base plate, where a mounting post is mounted on the base plate, and a rotating frame is rotatably connected to the mounting post;

where the rotating frame includes a rotating cylinder rotatably sleeved over the mounting post, a rotating ring is fixedly connected to the rotating cylinder, and a plurality of placing frames are distributed along the circumferential direction of the rotating ring; the placing frame includes a first placing ring and a second placing ring distributed in a layer, the first placing ring and the second placing ring are both split rings, the first placing ring and the second placing ring are respectively welded and fixed with the rotating ring, and the first placing ring and the second placing ring are connected via a vertical bar.

The disclosure further provides that the first placing ring, the second placing ring and the vertical bars are of an integrated structure.

The disclosure further provides that the inner diameter of the first placing ring is larger than the inner diameter of the second placing ring.

The disclosure further provides that a first bearing is mounted on one end of the rotating cylinder and a second bearing is mounted on the other end of the rotating cylinder, the first bearing and the second bearing being respectively sleeved with the mounting post.

The disclosure further provides that one end of the mounting post is provided with an external thread, and a mounting cap is threadedly connected to the mounting post.

The disclosure further provides that the other end of the mounting post is fastened to the base plate via a screw.

The disclosure further provides that the mounting post is sleeved with a gasket and the second bearing overlaps the gasket.

The disclosure further provides that the mounting post is sleeved with a mounting cover, and the mounting cap is located inside the mounting cover.

The disclosure has the following advantageous effects: the first placing ring and the second placing ring can facilitate placing a vehicle-mounted cup with a handle, and since the rotating cylinder plays a rotating function, the vehicle-mounted cup is driven to rotate, and thus a cup holder is provided, which facilitates placement of the vehicle-mounted cup with a handle and is convenient for use.

### BRIEF DESCRIPTION OF DRAWINGS

In order to more clearly illustrate the embodiments of the disclosure or the technical solutions in the prior art, the drawings used in the embodiments or the prior art descriptions will be briefly described below, and it is obvious that the drawings in the following description are some embodiments of the disclosure, and other drawings can be obtained by a person skilled in the art without creative efforts.

FIG. 1 is a schematic perspective structural diagram showing a cup holder according to an embodiment of the disclosure;

FIG. 2 is a schematic explosion structural diagram showing a cup holder according to an embodiment of the disclosure;

FIG. 3 is a schematic front structural diagram showing a cup holder according to an embodiment of the disclosure;

FIG. 4 is a schematic structural diagram showing a section taken along line A-A of FIG. 3; and

FIG. 5 is a partial schematic structural diagram showing a cup holder according to an embodiment of the disclosure.

Reference numerals: 1. base plate; 2. mounting post; 21. external thread; 3. rotating frame; 31. rotating cylinder; 32. rotating ring; 33. placing frame; 331. first placing ring; 332. second placing ring; 333. vertical bar; 4. first bearing; 5. second bearing; 6. mounting cap; 7. screw; 8. gasket; 9. mounting cover; 10. support pad.

### DETAILED DESCRIPTION OF THE EMBODIMENTS

In order that the objects, aspects and advantages of the disclosure will become more apparent, a more particular description of the disclosure will be rendered by reference to the embodiments thereof which are illustrated in the appended drawings. It should be understood that the particular embodiments described herein are illustrative only and are not limiting.

In the description of the disclosure, it should be noted that, unless expressly specified or limited otherwise, the terms “mounted”, “connected to”, and “connected” are to be interpreted broadly, e.g. either fixedly or detachably, or integrally connected; the connection may be a mechanical connection or an electrical connection; it can be directly connected or indirectly connected through an intermediate medium, can be the communication between two elements, and can be a wireless connection or a wired connection. The specific meaning of the above terms in the disclosure can be understood in detail by a person skilled in the art.

In describing the disclosure, it should be noted that the terms “central”, “upper”, “lower”, “left”, “right”, “vertical”, “horizontal”, “inner”, “outer”, and the like designate orientations or positional relationships based on the orientation or positional relationships shown in the drawings, are merely for convenience in describing the disclosure and to simplify the description, and do not indicate or imply that the referenced devices or elements must have a particular orientation, be constructed and operated in a particular orientation, and thus should not be construed as limiting the disclosure. Further, the terms “first”, “second”, and “third” are used for descriptive purposes only and are not to be construed as indicating or implying relative importance.

Further, the technical features involved in the different embodiments of the disclosure described below can be combined with each other as long as they do not conflict with each other.

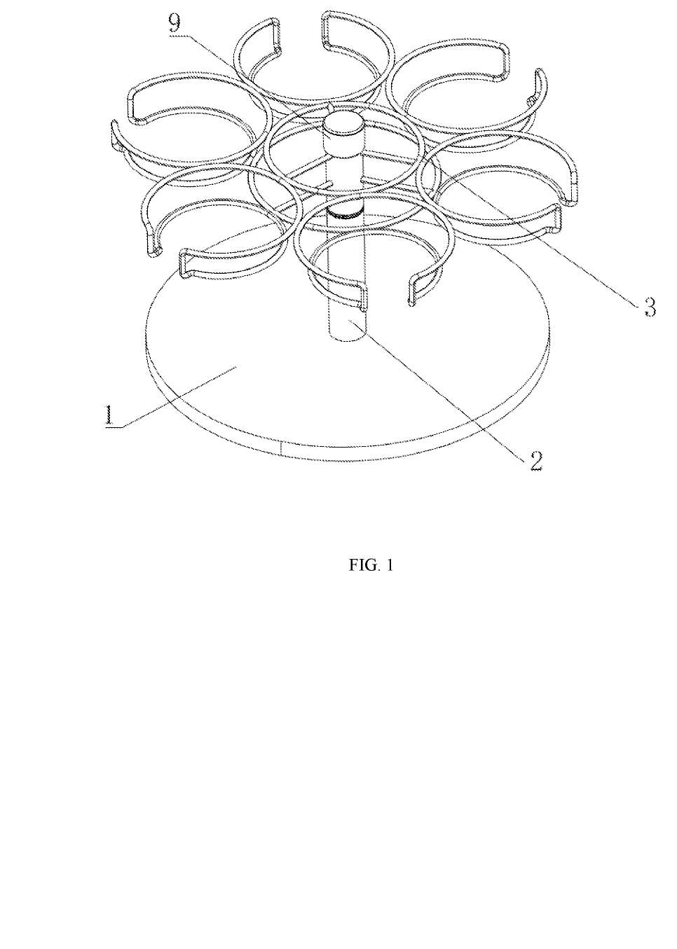

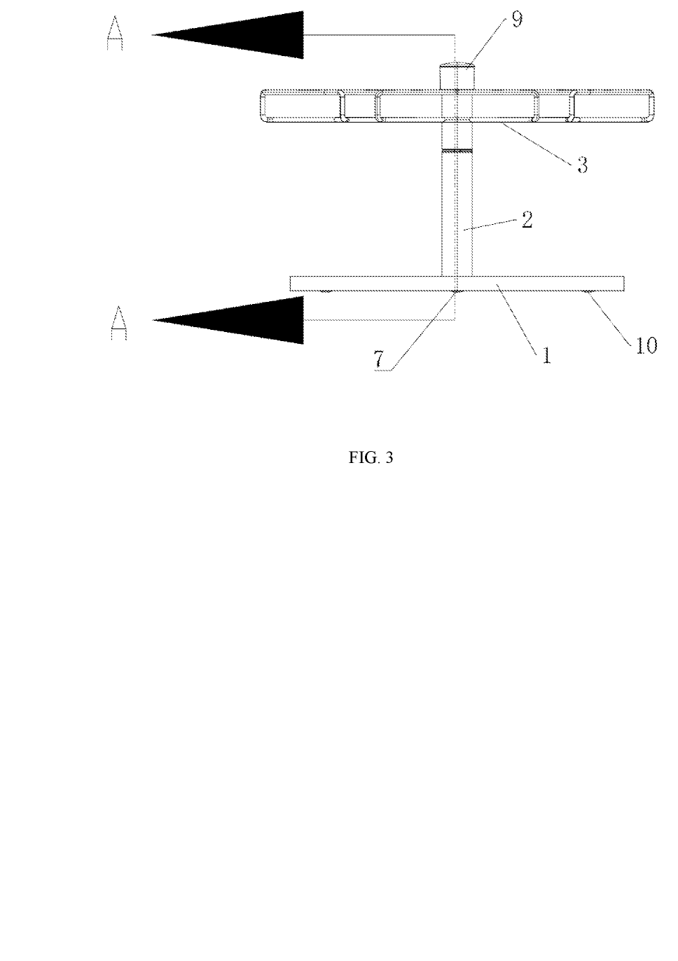

Disclosed in an embodiment of the disclosure is a cup holder, as shown in FIGS. 1-5, which includes: a base plate 1, a mounting post 2 mounted on the base plate 1, and a rotating frame 3 rotatably connected to the mounting post 2;

where the rotating frame 3 includes a rotating cylinder 31 rotatably sleeved over the mounting post 2, a rotating ring 32 is fastened to the rotating cylinder 31, and a plurality of placing frames 33 are distributed along the circumferential direction of the rotating ring 32; the placing frame 33 includes a first placing ring 331 and a second placing ring 332 distributed in a layer, the first placing ring 331 and the second placing ring 332 are both split rings, the first placing ring 331 and the second placing ring 332 are respectively welded and fixed with the rotating ring 32, and the first placing ring 331 and the second placing ring 332 are connected via a vertical bar 333. In the present embodiment, support pads 10 are fixedly mounted at the bottom of the base plate 1, and the number of the support pads 10 is four.

It should be noted that the first placing ring 331 and the second placing ring 332 can facilitate placing a vehicle-mounted cup with a handle, and since the rotating cylinder 31 plays a rotating function, the vehicle-mounted cup is driven to rotate, and thus a cup holder is provided, which facilitates placement of the vehicle-mounted cup with a handle and is convenient for use.

As shown, the first placing ring 331, the second placing ring 332, and the vertical bar 333 are of an integrated structure. It should be noted that since the first placing ring 331, the second placing ring 332 and the vertical bar 333 are integrally formed, the vehicle-mounted cup can be more stably supported.

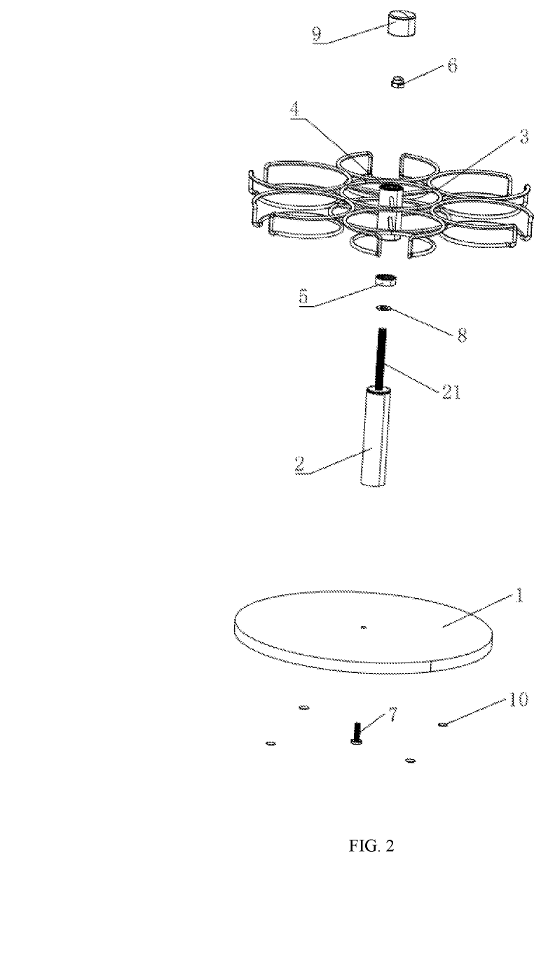

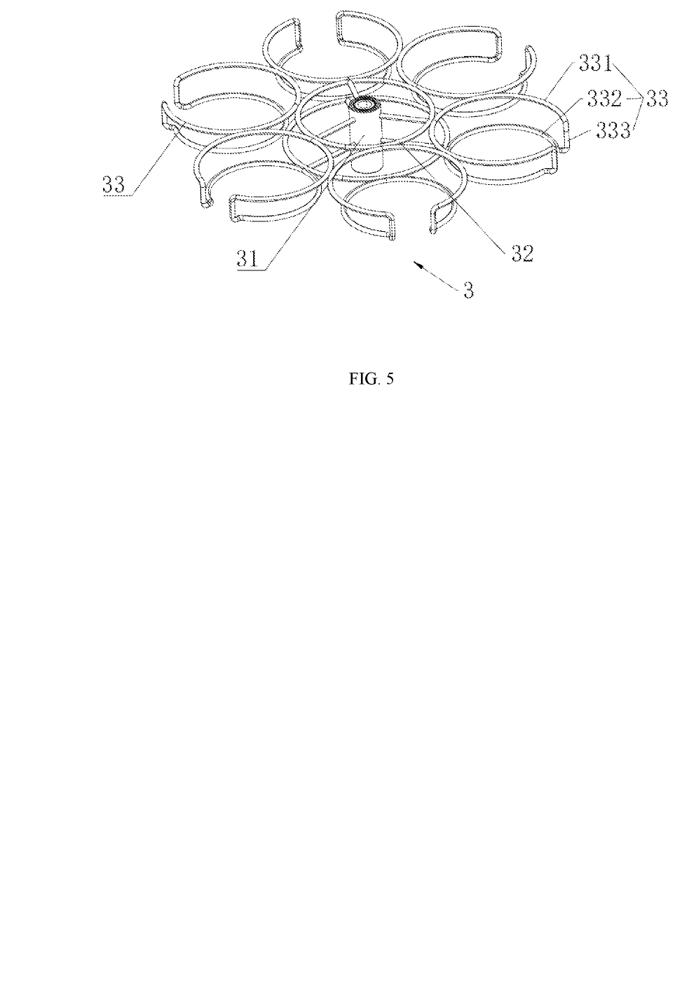

As shown in FIGS. 2 and 5, an inner diameter of the first placing ring 331 is larger than an inner diameter of the second placing ring 332. It should be noted that since the inner diameter of the first placing ring 331 is larger than the inner diameter of the second placing ring 332, the vehicle-mounted cup can be better placed.

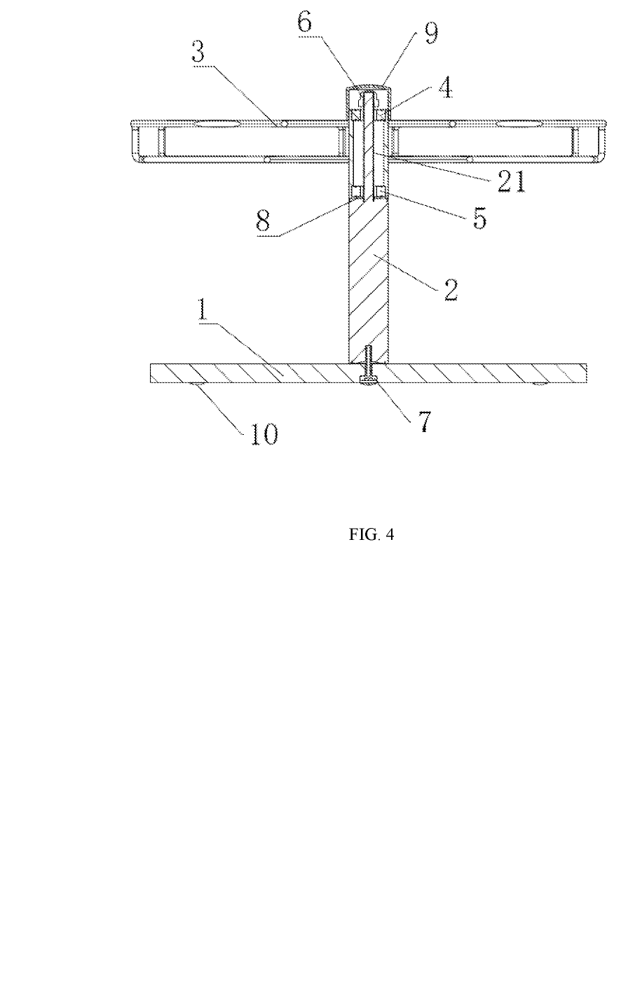

As shown in FIGS. 2 and 4, a first bearing 4 is mounted on one end of the rotating cylinder 31, a second bearing 5 is mounted on the other end of the rotating cylinder 31, and the first bearing 4 and the second bearing 5 are respectively sleeved with the mounting post 2. It should be noted that the provision of the first bearing 4 and the second bearing 5 enables the rotating cylinder 31 to smoothly rotate on the mounting post 2, and enhances the bearing of the rotating frame 3 against the weight of the vehicle-mounted cup.

As shown in FIGS. 2 and 4, one end of the mounting post 2 is provided with an external thread 21, and the mounting cap 6 is threadedly connected on the mounting post 2. It should be noted that the rotating frame 3 is limitedly mounted on the mounting post 2 by the mounting cap 6 being threadedly connected to the mounting post 2, thereby preventing the rotating frame 3 from rotating out.

As shown in FIGS. 1-5, the other end of the mounting post 2 is fastened to the base plate 1 via a screw 7. It should be noted that since the other end of the mounting post 2 is fastened to the base plate 1 via a screw 7, the mounting post 2 is conveniently fixedly mounted and conveniently dismounted.

As shown in FIGS. 2 and 4, the mounting post 2 is sleeved with a gasket 8, and the second bearing 5 overlaps the gasket 8. It should be noted that the bearing capacity of the rotating cylinder 31 is further enhanced by the provision of the gasket 8.

As shown in FIGS. 1-5, the mounting post 2 is sleeved with a mounting cover 9, and the mounting cap 6 is located inside the mounting cover 9. It should be noted that the mounting cap 6 can be hiddenly mounted by the provision of the mounting cover 9 to beautify the cup holder.

Working principle: the first placing ring 331 and the second placing ring 332 can facilitate placing a vehicle-mounted cup with a handle, and since the rotating cylinder 31 plays a rotating function, the vehicle-mounted cup is driven to rotate, and thus a cup holder is provided, which facilitates placement of the vehicle-mounted cup with a handle and is convenient for use.

It is to be understood that the above-described embodiments are merely illustrative for clarity and are not restrictive of the embodiments. It will be apparent to a person skilled in the art that various other modifications and variations can be made in the disclosure without departing from the scope or spirit of the disclosure. All embodiments need not be, and cannot be, exhaustive. Obvious modifications or variations are possible in light of the above teachings.

What is claimed is:

1. A cup holder, comprising: a base plate (1), wherein a mounting post (2) is mounted on the base plate (1), and a rotating frame (3) is rotatably connected to the mounting post (2);
wherein the rotating frame (3) comprises a rotating cylinder (31) rotatably sleeved over the mounting post (2), a rotating ring (32) is fixedly connected to the rotating cylinder (31), and a plurality of placing frames (33) are distributed along the circumferential direction of the rotating ring (32); the placing frame (33) comprises a first placing ring (331) and a second placing ring (332) distributed in a layer, the first placing ring (331) and the second placing ring (332) are both split rings, the first placing ring (331) and the second placing ring (332) are respectively welded and fixed with the rotating ring (32), and the first placing ring (331) and the second placing ring (332) are connected via a vertical bar (333).

2. The cup holder according to claim 1, wherein the first placing ring (331), the second placing ring (332) and the vertical bar (333) are of an integrated structure.

3. The cup holder according to claim 1, wherein an inner diameter of the first placing ring (331) is larger than an inner diameter of the second placing ring (332).

4. The cup holder according to claim 2, wherein an inner diameter of the first placing ring (331) is larger than an inner diameter of the second placing ring (332).

5. The cup holder according to claim 1, wherein a first bearing (4) is mounted on one end of the rotating cylinder (31) and a second bearing (5) is mounted on the other end of the rotating cylinder (31), the first bearing (4) and the second bearing (5) being respectively sleeved with the mounting post (2).

6. The cup holder according to claim 5, wherein one end of the mounting post (2) is provided with an external thread (21), and a mounting cap (6) is threadedly connected to the mounting post (2).

7. The cup holder according to claim 6, wherein the other end of the mounting post (2) is fastened to the base plate (1) via a screw (7).

8. The cup holder according to claim 5, wherein the mounting post (2) is sleeved with a gasket (8) and the second bearing (5) overlaps the gasket (8).

9. The cup holder according to claim 6, wherein the mounting post (2) is sleeved with a mounting cover (9), and the mounting cap (6) is located inside the mounting cover (9).
